(19) United States
(12) Patent Application Publication
(10) Pub. No.: US 2015/0138474 A1
(43) Pub. Date: May 21, 2015

(54) LIQUID CRYSTAL DISPLAY WITH ULTRA-NARROW FRAME AND COF PACKAGING STRUCTURE OF DRIVING CIRCUIT THEREOF

(71) Applicant: SHENZHEN CHINA STAR OPTOELECTRONICS TECHNOLOGY CO., LTD., Shenzhen, Guangdong (CN)

(72) Inventors: Jun Kai Chang, Shenzhen (CN); Chih Hao Wu, Shenzhen (CN)

(21) Appl. No.: 14/240,374

(22) PCT Filed: Jan. 17, 2014
(86) PCT No.: PCT/CN2014/070835

§ 371 Date: Jun. 5, 2014

(30) Foreign Application Priority Data
Oct. 12, 2013 (CN) 201310477362.5

(51) Int. Cl. G02F 1/133

(52) U.S. Cl. CPC G02F 1/13306
USPC 349/43

(57) ABSTRACT

The present invention provides an ultra-narrow frame liquid crystal display and a COF packaging structure for driving circuits in the ultra-narrow frame liquid crystal display. The COF packaging structure comprises: a sheet of flexible circuit board, with one side thereof bonded with a frame area of a glass substrate of the liquid crystal display, serving as a carrier sheet for chip-on-film flexible packaging; and a plurality of driving chips, bonded with the sheet of flexible circuit board sequentially along a scan direction, wherein a signal circuit between adjacent driving chips is arranged on the sheet of flexible circuit board. The present invention proposes a novel COF packaging structure, wherein the signal circuits required between the driving ICs are relocated to the COF flexible circuit board from the glass substrate by using the sheet of flexible circuit board. By mean of this, a voltage drop caused by increase of the resistance of wires between the driving ICs in the case of the large-sized narrow frame design may be avoided, thereby the mura of the panel due to a drop of input voltage to the driving ICs caused by the narrow frame large-sized panel can be avoided, and the quality of the product is improved.

### FIELD OF THE INVENTION

The present disclosure relates to the field of liquid crystal display, and particularly to an ultra-narrow frame liquid crystal display and a COF packaging structure for driving circuits thereof.

### BACKGROUND OF THE INVENTION

Nowadays, the semiconductor packaging industry gradually develops various types of packaging designs to meet the requirements of various high-density packages, wherein the design concept of various packaging structures is mostly to make high-density packaged products thinner so as to be applicable to electronic products of increasingly thinner and shorter, such as a narrow frame liquid crystal display.

In a liquid crystal module assembly using a backlight module of light-emitting diodes, narrow frame design is a trend. The frame of the module assembly in an existing mature product may be made with a thickness of less than 5 mm, and it is further desired to be designed towards an ultra-narrow frame, particularly in the design of a large-sized and high-resolution module assembly. To implement the narrow-frame design and to develop the electronic products towards thinness, shortness, good functions and high speed, driving chip packaging technology is also developed towards lower thickness and smaller area, such as a chip-on-film (COF) flexible packaging assembly. In the COF flexible packaging assembly, driving chips (such as gate chips) are packaged on a surface of a flexible circuit board, and the flexible circuit board joints one end thereof with a surface of a glass substrate through a metal lug, and joints the other end thereof to a driving circuit board.

However, as the liquid crystal display adopts a narrow frame design, the edge of the glass substrate is getting narrower, so that the width of signal wires between the driving chips (also called driving ICs) are limited and the resistance thereof is thereby relatively high. While, in the design of a large-sized liquid crystal display, the wires are longer, so the resistance is increased more, and a voltage drop is generated after a signal passes through such high-resistance wires. Accordingly, for different driving ICs, a signal output thereby may be getting weaker when the driving IC is getting far away from a control board, so that a related mura phenomenon is caused.

Detail description will be made below with reference to FIG. 1, FIG. 2 and FIG. 3.

As shown in FIG. 1, it is a plane schematic diagram of an LCD in the prior art. With reference to FIG. 1, the LCD 1 includes a liquid crystal panel 10, wherein COF packaging for driving circuits are respectively configured on a frame area 12 at the upper side and left side of display area 11 in the liquid crystal panel 10.

A plurality of gate flexible printed circuit boards (FPCs) 50, each including a driving IC 60, are mounted on the left side of the frame area 12 where gate pad electrodes are included. A plurality of source FPCs 20, each including a driving IC 30, are mounted on the upper side of the frame area 12 where data pad electrodes are included. Printed circuit boards (PCBs) 40 are in contact with, through the FPCs 20, the data pad electrodes connected to data lines.

A signal circuit (also called a wire) between two adjacent driving ICs is shown as an area 14 or 16 in the figure, and the wire is located on the glass substrate of the liquid crystal panel 10. Specifically, with reference to FIG. 2, the area 14 is the wire between two gate driving ICs 60, and the area 80 is a wire of the chip.

Due to the trend of narrow frame, namely, the frame area 12 is minimized, the wire 14 is narrowed along with narrowing of the edge of the glass substrate, and the cross section area of the wire 14 is reduced, so that resistance in per unit length may rise. If the size of the panel is increased, then the wire is longer, and thereby the resistance also rises. As shown in FIG. 3, according to a linear resistance formula ΔV=IR, if R is increased, ΔV is also increased. Therefore, the potential of the voltage output by a second gate drive 02 in FIG. 3 is lower than that of a first gate drive 01.

Therefore, how to solve the above-mentioned problems so that the resistance between the driving chips is not subjected to the width of the narrow frame glass substrate to lower the resistance of the wires is one of the problems dedicated in the domain.

### SUMMARY OF THE INVENTION

One of the technical problems to be solved in the present disclosure is to provide a COF packaging structure of a driving circuit of an ultra-narrow frame liquid crystal display, which enables the resistance between the driving chips not subjected to width of a narrow frame glass substrate and thereby reduces the resistance of wires. In addition, an ultra-narrow frame liquid crystal display is also provided.

To solve the above-mentioned technical problems, the present disclosure provides an ultra-narrow frame liquid crystal display, comprising: a glass substrate, an upper surface of which is divided into a display area and a frame area surrounding the display area, wherein a plurality of pixel assemblies are distributed on the display area in an array manner, and each pixel assembly includes a thin-film transistor for controlling display of the pixel assembly; and a gate driving circuit, placed on a gate driving side of the frame area, for controlling turn-on and turn-off of the thin-film transistor in the display area, wherein the gate driving circuit uses a chip-on-film flexible packaging comprising: a sheet of gate flexible circuit board with one side thereof bonded with the gate driving side of the frame area; and a plurality of gate driving chips, bonded with the sheet of gate flexible circuit board sequentially along a gate scan direction, wherein a signal circuit between adjacent gate driving chips is arranged on the sheet of gate flexible circuit board.

In one embodiment, the ultra-narrow frame liquid crystal display further comprising: a source driving circuit, placed on a source driving side of the frame area, for controlling a voltage of the pixel assemblies in the display area, wherein the source driving circuit uses a chip-on-film flexible packaging comprising: a sheet of source flexible circuit board with one side thereof bonded with the source driving side of the frame area; and a plurality of source driving chips, bonded with the sheet of source flexible circuit board sequentially along a source scan direction , wherein a signal circuit between adjacent source driving chips is arranged on the sheet of source flexible circuit board.

In one embodiment, the ultra-narrow frame liquid crystal display further comprising: a control signal printed circuit board, electrically connected with the other side of the source flexible circuit board.

In one embodiment, each gate driving chip is electrically connected to the gate driving side of the frame area through a wire.

In one embodiment, the wire is a fan-out wire portion, a plurality of wires of which is arranged as a fan shape.

According to the other aspect of the present disclosure, a chip-on-film packaging structure for driving circuits of an ultra-narrow frame liquid crystal display is also provided, comprising: a sheet of flexible circuit board with one side thereof bonded with a frame area of a glass substrate of the liquid crystal display panel, serving as a carrier sheet for chip-on-film flexible packaging; and a plurality of driving chips, bonded with the sheet of flexible circuit board sequentially along a scan direction, wherein a signal circuit between adjacent driving chips is arranged on the sheet of flexible circuit board.

In one embodiment, each driving chip is electrically connected to the frame area through a wire.

In one embodiment, the wire is a fan-out wire portion, a plurality of wires of which is arranged as a fan shape.

Compared with the prior art, one or more embodiments of the present disclosure may have the following advantages:

The present disclosure proposes a novel COF packaging structure, wherein the signal circuits required between the driving ICs are relocated to the COF flexible circuit board from the glass substrate by using the sheet of flexible circuit board. By mean of this, a voltage drop caused by increase of the resistance of wires between the driving ICs in the case of the large-sized narrow frame design may be avoided, thereby the mura of the panel due to a drop of input voltage to the driving ICs caused by the narrow frame large-sized panel can be avoided, and the quality of the product is improved.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings are provided for further understanding the present disclosure, and constitute a part of the description for interpreting the present disclosure together with the examples of the present disclosure, rather than limiting the present disclosure. In the accompanying drawings:

FIG. 1 is a plane structural schematic diagram of a narrow frame liquid crystal display in the prior art;

FIG. 2 is a local schematic diagram of COF packaging for driving circuits of the narrow frame liquid crystal display in the prior art;

FIG. 3 is a schematic diagram of a circuit structure of the liquid crystal display in the prior art;

FIG. 4 is a plane structural schematic diagram of a narrow frame liquid crystal display according to one example of the present disclosure;

FIG. 5 is a local schematic diagram of a COF packaging structure in the narrow frame liquid crystal display according to one example of the present disclosure;

FIG. 6 is a plane structural schematic diagram of a narrow frame liquid crystal display according to another example of the present disclosure.

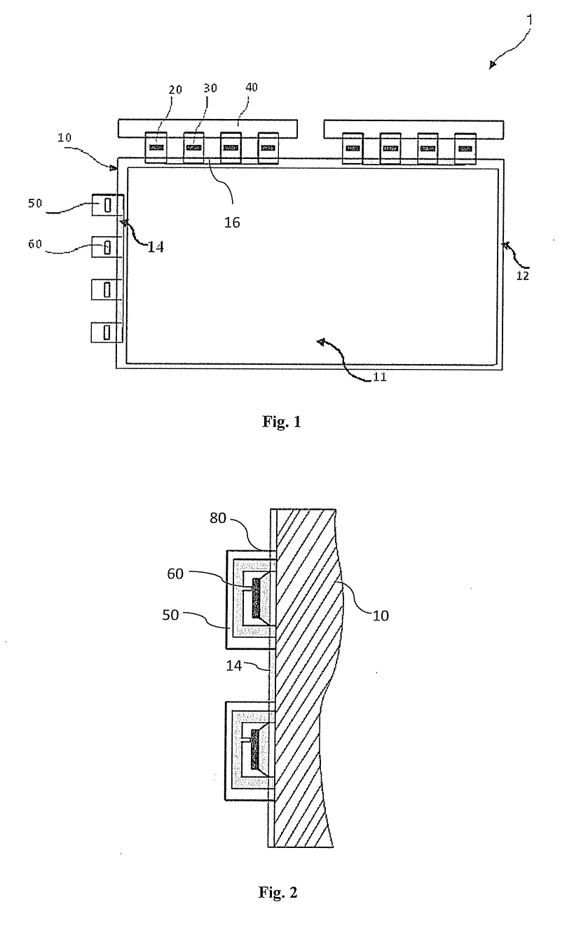

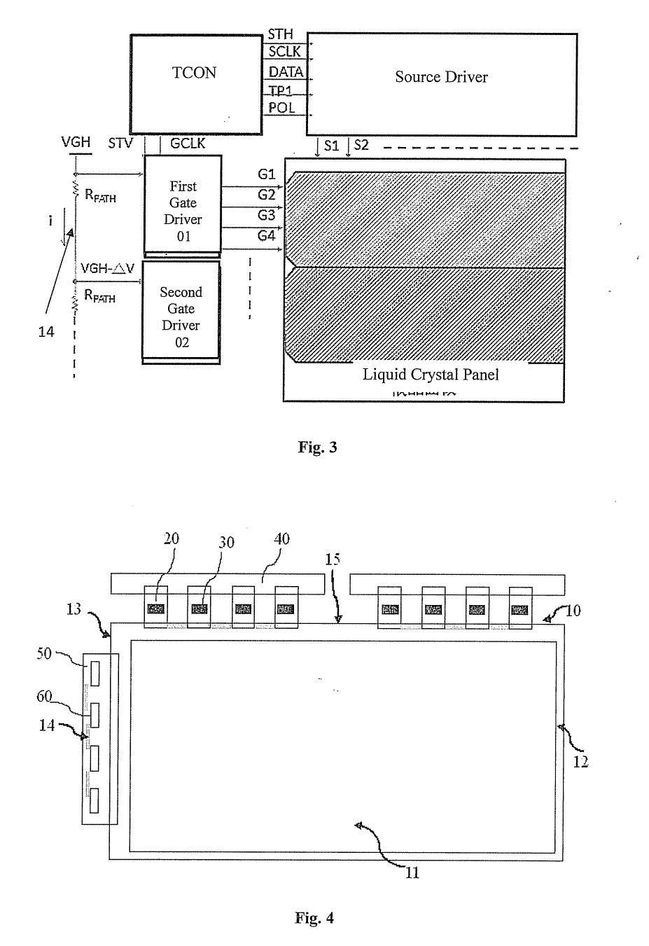

### DETAILED DESCRIPTION OF THE EMBODIMENTS

To make the objectives, technical solutions and advantages of the present disclosure clearer, the present disclosure is further illustrated in detail below in conjunction with the accompanying drawings.

To make the above-mentioned objectives, features and advantages of the present disclosure more obvious and readily to understand, preferred examples of the present disclosure will be specially exemplified below and illustrated in detail in conjunction with the accompanying drawings. Moreover, for directional terminology referred in the present disclosure, such as upper, lower, front, back, left, right, inner, outer, side and the like, reference is merely made to the directions of accompanying drawings. Accordingly, the adopted directional terms are used for illustrating and understanding rather than limiting the present disclosure.

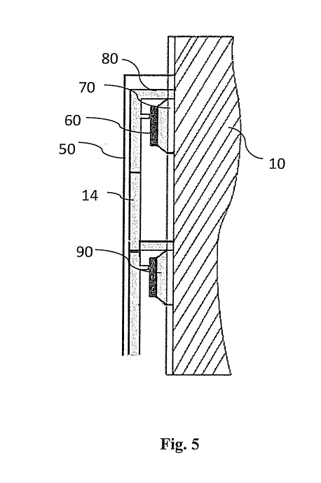

Referring to FIG. 4 and FIG. 5, FIG. 4 is a plane schematic diagram of a narrow frame liquid crystal panel according to one example of the present disclosure, and FIG. 5 is a schematic diagram of a COF packaging structure.

As shown in FIG. 4, the liquid crystal display mainly includes a liquid crystal panel 10, wherein the liquid crystal panel 10 includes a glass substrate, the upper surface of which is divided into a display area 11 and a frame area 12. A plurality of pixel assemblies (not shown) are distributed on the display area 11 in an array manner, and each pixel assembly includes a thin-film transistor for controlling display of the pixel assembly. The frame area 12 surrounds the display area 11, and the COF packaging for driving circuits is configured on the frame area 12 of the glass substrate respectively.

The driving circuits include gate driving circuits prepared on a gate driving side 13 of the frame area 12 and configured to control the turn-on and turn-off of the thin-film transistor in the display area 11. The driving circuits also include source driving circuits prepared on a source driving side 15 of the frame area 12 and configured to control the voltage of the pixel assembly in the display area 11, and a control signal printed circuit board 40 electrically connected with the source driving circuit.

As shown in FIG. 4, the gate driving circuit adopts a chip-on-film flexible packaging, and a structure of the flexible packaging includes: a sheet of gate flexible circuit board 50 with one side thereof jointed with the gate driving side 13 of the frame area; and a plurality of gate driving chips 60, bonded with the sheet of gate flexible circuit board 50 sequentially along a gate scan direction, wherein a signal circuit 14 between the adjacent gate driving chips is arranged on the sheet of gate flexible circuit board 50.

Different from the prior art, the wire between the two adjacent gate driving chips in this example, shown as the area 14 in FIG. 4, is not arranged on the left side of the frame area 12 of the glass substrate, but on a whole-piece flexible circuit board.

More specifically, shown in FIG. 5 is a local schematic diagram of a COF packaging structure, wherein gate driving chips 60 and a wire (circuit portions) 90 are arranged on the gate flexible circuit board 50. In addition, area 80 is a wire related to the driving chip 60 itself, and the signal circuit between the two adjacent gate driving chips is the area 14. Each driving chip 60 is electrically connected to the gate driving side 13 of the glass substrate through the wire 90, and forms a junction 70 with the glass substrate. As shown in the figure, each wire 90 is a fan-out wire portion, namely a plurality of wires of the wire 90 are together formed as a fan-like shape.

As the wire between the two adjacent gate driving chips in this example is arranged on the sheet of flexible circuit board, when the liquid crystal display is packaged, only the sheet of flexible circuit board is bent to a lateral surface of the liquid crystal panel or to a bottom surface of a back plate. In this case, when a narrow frame structure is desired, as the wires are not arranged on the edge of the glass substrate, the resistance of the wires is thereby controllable and not subjected to the width of the glass substrate.

However, in the prior art, when the plurality of gate driving chips are connected through a wire On Array (WOA), gate output signals from different gate driving chips are different. As resistors and capacitors may produce an RC delay effect during transmission due to connection via metal wires, in the given gate scan direction, the gate output signal of the chip on a second gate driving flexible board attenuates relative to that of the chip on a first gate driving flexible board, and the gate output signal of the chip on .a third gate driving flexible board attenuates relative to that of the chip on the second gate driving flexible board, and so on.

In order that the intensities of the output signals of respective driving chips along the given gate scan direction are equal and not subjected to the narrow frame, the wires between the driving chips are arranged on the sheet of flexible board. Then, it can be easily understood that if the circuits on the sheet of flexible board are designed to be wider, the resistance may be lower, so that the intensities of the output signals of the plurality of gate driving chips can be equal.

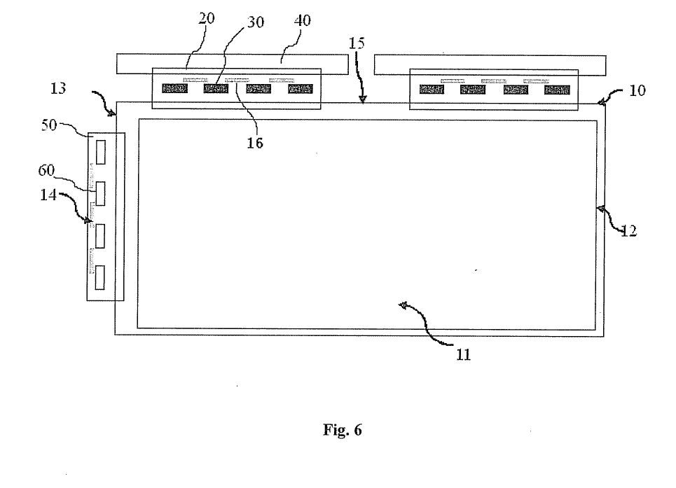

In addition, as shown in FIG. 6, a plane structural schematic diagram of a narrow frame liquid crystal display according to another example of the present disclosure is also provided. The difference of the structure of the present narrow frame liquid crystal display from the previous example is in that the source driving circuit also preferably adopts the chip-on-film flexible packaging, and a structure of the flexible packaging includes: a sheet of source flexible circuit board 20 with one side thereof jointed with the source driving side 15 of the frame area 12; and a plurality of source driving chips 30, bonded with the sheet of source flexible circuit board 20 sequentially along a source scan direction, wherein a signal circuit 16 between the adjacent source driving chips is arranged on the sheet of source flexible circuit board 20. Moreover, the other side of the sheet of source flexible circuit board 20 is electrically connected with a control signal circuit board 40.

In conclusion, the present disclosure proposes a novel COF packaging structure, wherein the signal circuits required between the driving ICs are relocated to a COF carrier sheet from the glass substrate. By mean of this, a voltage drop caused by increase of the resistance of the wires between the driving ICs in the case of the large-sized narrow frame design may be avoided, thereby the mura of the panel due to a drop of input voltage to the driving ICs caused by the narrow frame large-sized panel can be avoided, and the quality of the product is improved.

The foregoing descriptions are merely preferred specific embodiments of the present disclosure, but the protection scope of the present disclosure is not limited thereto. Any variations or alternatives readily conceivable to anyone familiar with this art within the technical scope of the present disclosure shall be incorporated into the protection scope of the present disclosure. Accordingly, the protection scope of the present disclosure should be subjected to the protection scope of the claims.

1. An ultra-narrow frame liquid crystal display, comprising:
a glass substrate, an upper surface of which is divided into a display area and a frame area surrounding the display area, wherein a plurality of pixel assemblies are distributed on the display area in an array manner, and each pixel assembly includes a thin-film transistor for controlling display of the pixel assembly; and
a gate driving circuit, placed on a gate driving side of the frame area, for controlling turn-on and turn-off of the thin-film transistor in the display area, wherein the gate driving circuit uses a chip-on-film flexible packaging comprising:
a sheet of gate flexible circuit board with one side thereof bonded with the gate driving side of the frame area; and
a plurality of gate driving chips, bonded with the sheet of gate flexible circuit board sequentially along a gate scan direction, wherein a signal circuit between adjacent gate driving chips is arranged on the sheet of gate flexible circuit board.

2. The ultra-narrow frame liquid crystal display of claim 1, wherein further comprising:
a source driving circuit, placed on a source driving side of the frame area, for controlling a voltage of the pixel assemblies in the display area, wherein the source driving circuit uses a chip-on-film flexible packaging comprising:
a sheet of source flexible circuit board with one side thereof bonded with the source driving side of the frame area; and
a plurality of source driving chips, bonded with the sheet of source flexible circuit board sequentially along a source scan direction, wherein a signal circuit between adjacent source driving chips is arranged on the sheet of source flexible circuit board.

3. The ultra-narrow frame liquid crystal display of claim 2, wherein further comprising:
a control signal printed circuit board, electrically connected with the other side of the source flexible circuit board.

4. The ultra-narrow frame liquid crystal display of claim 1, wherein each gate driving chip is electrically connected to the gate driving side of the frame area through a wire.

5. The ultra-narrow frame liquid crystal display of claim 4, wherein the wire is a fan-out wire portion, a plurality of wires of which is arranged as a fan shape.

6. A chip-on-film packaging structure for driving circuits of an ultra-narrow frame liquid crystal display, comprising:
a sheet of flexible circuit board, with one side thereof bonded with a frame area of a glass substrate of the liquid crystal display panel, serving as a carrier sheet for chip-on-film flexible packaging; and
a plurality of driving chips, bonded with the sheet of flexible circuit board sequentially along a scan direction, wherein a signal circuit between adjacent driving chips is arranged on the sheet of flexible circuit board.

7. The chip-on-film packaging structure of claim 6, wherein each driving chip is electrically connected to the frame area through a wire.

8. The chip-on-film packaging structure of claim 7, wherein the wire is a fan-out wire portion, a plurality of wires of which is arranged as a fan shape.
